(19) United States
(12) Patent Application Publication
(10) Pub. No.: US 2011/0105636 A1
(43) Pub. Date: May 5, 2011

(54) ORGANIC AEROGEL, COMPOSITION FOR THE MANUFACTURE OF THE ORGANIC AEROGEL, AND METHOD OF MANUFACTURING THE ORGANIC AEROGEL

(75) Inventors: Kwang-Hee KIM, Seoul (KR); Myung-Dong CHO, Hwaseong-si (KR); Sang-Ho PARK, Yongin-si (KR); Sung-Woo HWANG, Yongin-si (KR)

(73) Assignee: SAMSUNG ELECTRONICS CO., LTD., Suwon-si (KR)

(21) Appl. No.: 12/834,438

(22) Filed: Jul. 12, 2010

(30) Foreign Application Priority Data
Nov. 5, 2009 (KR) 10-2009-0106641

(51) Int. Cl. C08G 18/04

(52) U.S. Cl. 521/163; 521/175

(57) ABSTRACT

An organic aerogel including a polymer that is a reaction product of a substituted or unsubstituted alkyl cellulose compound or derivative thereof and a substituted or unsubstituted alkylene diphenyl diisocyanate compound, as well as a composition for the manufacture of an organic aerogel, and a method of manufacturing the organic aerogel.

### CROSS-REFERENCE TO RELATED APPLICATION

This application claims priority to Korean Patent Application No. 10-2009-0106641, filed on Nov. 5, 2009, and all the benefits accruing therefrom under 35 U.S.C. §119, the content of which in its entirety is herein incorporated by reference.

### BACKGROUND

1. Field

This disclosure relates to an organic aerogel, a composition for the manufacture of an organic aerogel, and a method of manufacturing the same.

2. Description of the Related Art

An aerogel is a microporous material having a three-dimensional mesh structure with dimensions on the nanometer scale. The aerogel may have insulating and sound absorbing properties, thus the aerogel may be utilized in a variety of applications. In particular, an aerogel may be used in a cooling device, such as a refrigerator and a freezer, as an aerospace material or as a building construction material.

Aerogels may be classified as an inorganic aerogel or an organic aerogel according to the starting material.

An example of an inorganic aerogel is a silica aerogel. An organic aerogel includes an organic linking group therein, and thus is less brittle than an inorganic aerogel.

### SUMMARY

An organic aerogel may have various properties according to its chemical structure and process of manufacture.

One aspect of this disclosure provides an organic aerogel having improved properties.

Another aspect of this disclosure provides a composition for the manufacture of an organic aerogel.

A further aspect of this disclosure provides a method of manufacturing the organic aerogel.

According to one aspect of this disclosure, an organic aerogel is provided that includes a polymer, the polymer including a reaction product of a substituted or unsubstituted alkyl cellulose compound or derivative thereof and a substituted or unsubstituted alkylene diphenyl diisocyanate compound.

The substituted or unsubstituted alkyl cellulose compound is a compound represented by Chemical Formula 1.

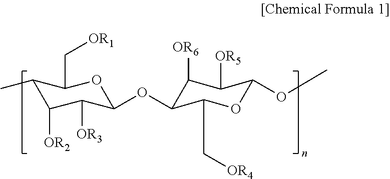

In Chemical Formula 1, R₁ to R₆ are each independently hydrogen or a C1 to C10 alkyl group, provided that at least one of R₁ to R₆ is a C1 to C10 alkyl group, and n is about 10 to about 1000.

The substituted or unsubstituted alkylene diphenyl diisocyanate compound is a compound represented by Chemical Formula 2

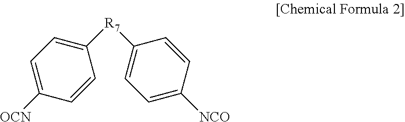

In Chemical Formula 2, R₇ is a C1 to C20 alkylene group.

The substituted or unsubstituted alkylene diphenyl diisocyanate compound may be methylene diphenyl diisocyanate as represented by Chemical Formula 2-1.

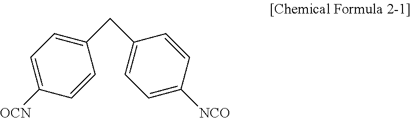

A cross-linkable compound having at least two vinyl groups may be included to increase a cross-linking density of the polymer.

The compound having at least two vinyl groups may include a substituted or unsubstituted multifunctional acrylate compound.

The organic aerogel may include a plurality of pores having an average pore size of about 2 nanometers (nm) to about 100 nm.

The polymer may have porosity of about 80 percent (%) to about 99%, based on the total volume of the polymer.

The organic aerogel may have a specific surface area of about 100 square meters per gram (m²/g) to about 1200 m²/g.

According to another aspect of this disclosure, a composition for the manufacture of an organic aerogel is provided, wherein the composition includes a substituted or unsubstituted alkyl cellulose compound or derivative thereof, a substituted or unsubstituted alkylene diphenyl diisocyanate compound, and a solvent.

The substituted or unsubstituted alkyl cellulose compound or derivative thereof is a compound represented by the Chemical Formula 1.

The substituted or unsubstituted alkylene diphenyl diisocyanate compound is a compound represented by the Chemical Formula 2.

The composition for the manufacture of an organic aerogel may further include a cross-linkable compound having at least two vinyl groups.

The compound having at least two vinyl groups may include a substituted or unsubstituted multifunctional acrylate compound.

According to a further aspect of this disclosure, a method of manufacturing an organic aerogel is provided that includes reacting a substituted or unsubstituted alkyl cellulose compound or derivative thereof and a substituted or unsubstituted alkylene diphenyl diisocyanate compound to form an organic aerogel polymer, and drying the obtained organic aerogel polymer.

The reacting may be performed at room temperature.

The reacting may be performed in the presence of an amine compound.

Before, during, or after reacting a crosslinkable compound having at least two vinyl groups may be further added, and the compound having at least two vinyl groups may include a substituted or unsubstituted multifunctional acrylate compound.

The cross-linking may be performed at about 40° C. to about 80° C. Alternatively, or in addition, the cross-linking may be performed in the presence of a radical initiator.

The organic aerogel may have shrinkage of about 20% or less after the drying is performed.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIGS. 1A to 5B are photographs showing shapes and pores of exemplary embodiments of organic aerogels according to Examples 1 and 2 and Comparative Examples 1 to 3;

FIG. 6 is a graph showing pore size distribution of organic aerogels, e.g., pore volume (cubic centimeters per gram versus pore diameter (nanometers), according to Examples 1 and 2; and

FIG. 7 is a graph showing thermal conductivity (Watts per meter per Kelvin) versus time (seconds) of an organic aerogel according to Example 2.

### DETAILED DESCRIPTION

Exemplary embodiments will be described more fully hereinafter with reference to the accompanying drawings. This disclosure may, however, be embodied in many different forms and is not to be construed as limited to the exemplary embodiments set forth herein. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer, or section from another element, component, region, layer, or section. Thus, a first element, component, region, layer or section discussed below could be termed a second element, component, region, layer, or section without departing from the teachings of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. As used herein, unless otherwise provided, the term “substituted” refers to a compound or radical substituted with at least one or more (e.g., 1, 2, 3, 4, 5, 6 or more) substituents independently selected from the group consisting of a C1 to C30 alkyl, a C2 to C30 alkynyl, a C6 to C30 aryl, a C7 to C30 arylalkyl, a C1 to C4 oxyalkyl, a C1 to C30 heteroalkyl, a C3 to C30 heteroarylalkyl, a C3 to C30 cycloalkyl, a C3 to C15 cycloalkenyl, a C6 to C30 cycloalkynyl, a C2 to C30 heterocycloalkyl, a halogen (e.g., F, Cl, Br, or I), a hydroxy, an alkoxy, a nitro, a cyano, an amino, an azido, an amidino, a hydrazino, a hydrazono, a carbonyl, a carbamyl, a thiol, an ester, a carboxyl or a salt thereof, a sulfonic acid or a salt thereof, a phosphoric acid or a salt thereof, and a combination thereof, instead of hydrogen.

As used herein, unless otherwise provided, the term “hetero” refers to a compound including 1 to 3 heteroatoms selected from the group consisting of N, O, S, and P.

Hereinafter, an organic aerogel according to an embodiment is described.

The organic aerogel includes a polymer having a plurality of micropores.

The organic aerogel includes a polymer which is a reaction product of a substituted or unsubstituted alkyl cellulose compound or derivative thereof (hereinafter referred to as an “alkyl cellulose compound”) and a substituted or unsubstituted alkylene diphenyl diisocyanate compound (hereinafter referred to as “alkylene diphenyl diisocyanate compound”), wherein the alkyl cellulose compound and the alkylene diphenyl diisocyanate compound.

The alkyl cellulose compound is a compound represented by Chemical Formula 1.

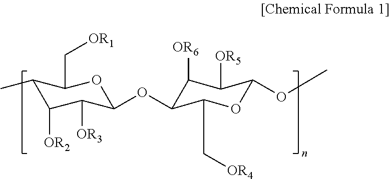

In the Chemical Formula 1, R₁ to R₆ are each independently hydrogen or a C1 to C10 alkyl group, provided that at least one of R₁ to R₆ is a C1 to C10 alkyl group, and n is about 10 to about 1000, specifically about 15 to about 900, more specifically about 20 to about 800.

The alkyl cellulose compound has a molecular weight of about 10,000 Daltons to about 300,000 Daltons, or in another embodiment, about 10,000 Daltons to about 50,000 Daltons, specifically about 20,000 Daltons to about 40,000 Daltons. The molecular weight of each repeating unit of the alkyl cellulose may be about 300 Daltons to about 1000 Daltons, specifically about 400 Daltons to about 500 Daltons, more specifically about 450 Daltons.

The alkyl cellulose compound may be ethyl cellulose in which at least one of R₁ to R₆ is an ethyl group.

The alkylene diphenyl diisocyanate compound is a compound represented by Chemical Formula 2.

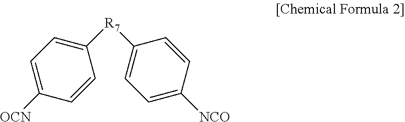

In Chemical Formula 2, R₇ is a C1 to C20 alkylene group.

The alkylene diphenyl diisocyanate compound may include methylene diphenyl diisocyanate, which is represented by Chemical Formula 2-1.

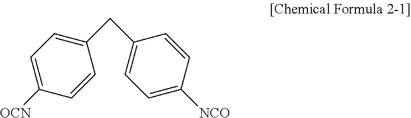

The alkyl cellulose compound and the alkylene diphenyl diisocyanate compound may be reacted in a solvent.

The solvent may be an organic solvent, for example dimethyl formamide, acetone, 1,4-dioxane, tetrahydrofuran, dimethylsulfoxide, toluene, benzene, dichlorobenzene, acetonitrile, alcohol, or a combination comprising at least one of the foregoing.

The organic aerogel according to another embodiment includes a polymer wherein the alkyl cellulose compound, the alkylene diphenyl diisocyanate compound, and a substituted or unsubstituted compound including at least two vinyl groups (hereinafter referred to as a “vinyl compound”) are cross-linked. As used herein, a “vinyl” group includes any group having terminal unsaturation (—CH₂═CH₂), including acrylate groups (—OC(O)CH═CH₂) and methacrylate (—OC(O)(CH₃)═CH₂) groups.

While not wanting to be bound by theory, it is believed that the vinyl compound increases the cross-linking density of the polymer to form dense micropores, resulting in an improvement of the strength of the organic aerogel.

The vinyl compound may include a substituted or unsubstituted acrylate compound.

The vinyl compound may include, for example, divinylbenzene, pentaerythritol triacrylate, trimethylolpropane triacrylate, pentaerythritol tetraacrylate, dipentaerythritol pentaacrylate as represented by the following Chemical Formula 3, or a combination comprising at least one of the foregoing.

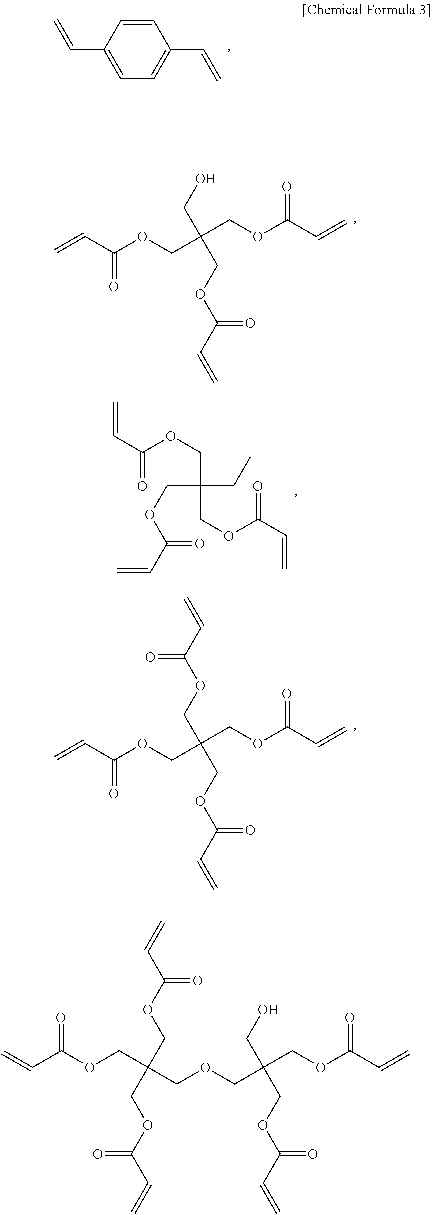

In an embodiment, the vinyl compound is mixed with the alkyl cellulose compound and the alkylene diphenyl diisocyanate compound in a solvent to form a cross-linked organic aerogel polymer.

The organic aerogel may include a plurality of nano-scale pores in a polymer. The mesopores are fine pores having a pore size of about 2 nanometers (nm) to about 100 nm, specifically about 4 nm to about 90 nm, more specifically about 6 nm to about 80 nm. The polymer may have a porosity of about 80 percent (“°/0”) to about 99%, specifically about 85% to about 98%, more specifically about 90% to about 95%, based on the total volume of the polymer. The organic aerogel has a high specific surface area due to the fine pores and high porosity. The organic aerogel may have a specific surface area of about 100 square meters per gram (m²/g) to about 1200 m²/g, specifically about 150 m²/g to about 800 m²/g, more specifically about 200 m²/g to about 600 m²/g.

The organic aerogel includes a polymer of the alkyl cellulose derivative and the alkylene diphenyl diisocyanate compound to provide flexibility to the aerogel, and is durable to external impact.

When the organic aerogel further includes across-linked vinyl compound, the cross-linking density is increased to provide a fine pore structure. Accordingly, a high specific surface area is provided and shrinkage is reduced during drying to inhibit a change of an external shape of the organic aerogel.

Because the organic aerogel has a microstructure including branch-shaped clusters from a plurality of mesopores, it has high structural strength and flexibility. Due to the high structural strength and flexibility, the mesopores are not collapsed during their preparation and have a selected pore size, resulting in a high specific surface area and adiabatic properties of the organic aerogel.

The organic aerogel according to an embodiment has shrinkage of about 20% or less, in another embodiment about 15% or less, and in a further embodiment, about 10% or less. The shrinkage of the organic aerogel may be 0 to about 20%, specifically about 1% to about 15%, more specifically about 2% to about 10%.

Hereinafter, a method of preparing the organic aerogel is described.

In an embodiment, the organic aerogel is prepared as a wet gel by polymerizing a composition for the manufacture of an organic aerogel, followed by drying.

First, a composition for the manufacture of an organic aerogel is disclosed.

The composition for the manufacture of an organic aerogel according to an embodiment includes an alkyl cellulose compound, an alkylene diphenyl diisocyanate compound, and a solvent.

The alkyl cellulose compound, which includes a compound represented by Chemical Formula 1, and the alkylene diphenyl diisocyanate compound, which includes a compound represented by Chemical Formula 2, are mixed in a solvent.

The solvent may be any organic solvent that is capable of dissolving the alkyl cellulose compound and alkylene diphenyl diisocyanate compound, and may be, for example, dimethyl formamide, acetone, 1,4-dioxane, tetrahydrofuran, dimethylsulfoxide, toluene, benzene, dichlorobenzene, acetonitrile, alcohols, or a combination comprising at least one of the foregoing.

The alkyl cellulose compound and alkylene diphenyl diisocyanate compound may be included at an equivalent ratio of about 0.5:1 to about 1:0.5, specifically about 0.7:1 to about 1:0.7, more specifically about 1:1. The alkyl cellulose compound and alkylene diphenyl diisocyanate compound may be included in an amount of about 40 weight percent (“wt %) to about 60 wt % and about 60 weight percent (“wt %) to about 40 wt %, specifically about 45 wt % to about 55 wt % and about 55 wt % to about 45 wt %, more specifically about 47 wt % to about 53 wt % and about 53 wt % to about 47 wt %, respectively, based on the total amount of the composition for an organic aerogel.

The composition for the manufacture of an organic aerogel may be reacted (cross-linked) at room temperature, for example at about 20° C. to about 25° C. During the cross-linking reaction, an amine compound may be present as a catalyst. The amine compound may include a pyridine, such as methylpyridine, or an aliphatic amine such as triethylamine, or a combination comprising at least one of the foregoing.

Through such the cross-linking reaction, a wet gel is provided.

The wet gel may undergo a solvent exchange reaction. The solvent may include any solvent having good liquid compatibility with carbon dioxide, without limitation. However, when the wet gel is dried under atmospheric pressure, or the solvent used during preparation of the wet gel has sufficient compatibility with carbon dioxide, any solvent exchange process may be omitted.

Subsequently, the wet gel is dried. The drying is performed, for example, by supercritical drying, atmospheric pressure drying, lyophilizing (i.e., reduced pressure drying), or a combination thereof.

The supercritical drying uses supercritical carbon dioxide. First, liquid carbon dioxide is supplied in a high-pressure reactor to remove the solvent in a wet gel. Then the temperature and pressure of the high-pressure reactor are raised over the threshold points of carbon dioxide, and the carbon dioxide is removed by slowly ejecting (e.g., venting) the carbon dioxide under reduced pressure. The supercritical drying may be performed at room temperature, and has good processability and safety.

The atmospheric pressure drying method includes drying the wet gel by heating the wet gel at atmospheric pressure or in a vacuum condition. When the solvent is removed through the atmospheric pressure drying method the resulting product is called a xerogel, which is a kind of aerogel.

Lyophilizing (or reduced pressure drying) is a method of removing solvent by freezing the wet gel, which may include an aqueous solution, and reducing the pressure to sublimate frozen solvent (e.g., ice). When the solvent is removed through the lyophilizing (or reduced pressure drying) the resulting product is called a cryogel, which is a type of aerogel.

The composition for the manufacture of an organic aerogel according to an embodiment may further include a vinyl compound in addition to the alkyl cellulose compound and alkylene diphenyl diisocyanate compound. The vinyl compound may include a substituted or unsubstituted multifunctional acrylate compound.

The vinyl compound is the same as disclosed above.

The vinyl compound may be mixed with the alkyl cellulose compound and alkylene diphenyl diisocyanate compound in a solvent.

The alkyl cellulose compound, the alkylene diphenyl diisocyanate compound, and the vinyl compound may be included at an equivalent ratio of about 0.4:0.6:1 to about 0.6:0.4:1, specifically about 0.45:0.55:1 to about 0.55:0.45:1, more specifically about 0.52:0.48:1, respectively. Also the alkyl cellulose compound, the alkylene diphenyl diisocyanate compound, and the vinyl compound may be included in amount of about 20 wt % to about 30 wt %, 30 wt % to about 20 wt %, and about 50 wt %, more specifically about 22.5 wt % to about 27.5 wt %, about 27.5 wt % to about 22.5 wt %, and about 50 wt %, respectively. In order to obtain a dense cross-linking network structure, the amount of a vinyl group may be increased up to about 50 wt % or more.

The composition for the manufacture of an organic aerogel including the alkyl cellulose compound, the alkylene diphenyl diisocyanate compound, and the vinyl compound may be subject to two (or more) step reaction process that includes a primary reaction, i.e., a primary cross-linking reaction at room temperature in the presence of an amine compound. The primary cross-linking reaction occurs between the alkyl cellulose compound and the alkylene diphenyl diisocyanate compound.

The compound that undergoes the primary cross-linking reaction is then thermally polymerized through secondary cross-linking, optionally in the presence of a radical initiator. The thermal polymerization may be performed at about 40° C. to about 80° C., specifically about 60° C. to about 80° C., more specifically about 70° C. The radical initiator may be any compound capable of generating a radical, and may include, for example, at least one of 2,2-azobisisobutyronitrile (“AIBN”), ammonium persulfate (“APS”), potassium persulfate, sodium persulfate, benzoyl peroxide (“BPO”), and diisopropyl peroxy carbonate.

The secondary cross-linking increases a cross-linking degree of the primarily cross-linked compound to provide an interpenetrating network (“IPN”) structure in a polymer.

Through the primary and the secondary cross-linking reactions, a wet gel with an interpenetrating network structure is provided.

The wet gel may be subjected to a solvent exchange reaction.

Subsequently, the wet gel is dried. The drying is performed, for example; by supercritical drying, atmospheric pressure drying, lyophilizing (i.e., reduced pressure drying), or a combination thereof.

Hereinafter, this disclosure is illustrated in further detail with reference to examples. However, the exemplary embodiments of this disclosure shall not be limiting.

### Preparation of an Organic Aerogel

### Example 1

A 1.0 gram (g) amount of ethyl cellulose and 1.0 g of methylene diphenyl diisocyanate are dissolved in 10 milliliters (mL) of acetone in a cylindrical polypropylene vial, and then 0.01 g of pyridine as a catalyst is added to the solution. The ethyl cellulose is available from Sigma-Aldrich Corporation, and includes 5% of ethyl cellulose in a mixed solvent of toluene/ethanol at an 80:20 volume ratio and 48% of an ethoxyl substitution ratio.

The obtained product is allowed to stand for 4 hours at room temperature. The formation of the gel is detected by seeing if the interface flows or not.

The wet gel is subjected to solvent-exchange with acetone, which has good compatibility with liquid carbon dioxide. Then liquid carbon dioxide is supplied to a high-pressure reactor to remove acetone in the wet gel. When the acetone is completely removed from the wet gel, the temperature and pressure are raised over the threshold points of carbon dioxide. Then, the carbon dioxide is slowly ejected to reduce the pressure while maintaining the temperature at over the threshold temperature.

### Example 2

A 1.0 g amount of ethyl cellulose and 1.0 g of methylene diphenyl diisocyanate are mixed in a cylindrical polypropylene vial, and 0.4 g of pentaerythritol triacrylate is added to the mixture and they are dissolved in 10 mL of acetone to provide a solution. A 0.01 g amount of pyridine is added to the solution to catalyze a reaction between ethyl cellulose and methylene diphenyl diisocyanate, and AIBN is added as a radical initiator.

The obtained solution is allowed to stand for 4 hours at room temperature to perform primary cross-linking. The formation of the wet gel is detected by seeing if the interface flows or not. The wet gel is allowed to stand overnight at 60° C. to perform secondary cross-linking.

The wet gel obtained by the secondary cross-linking is subjected to solvent-exchange with acetone, which has good compatibility with liquid carbon dioxide. Then liquid carbon dioxide is supplied to a high-pressure reactor to remove acetone in the wet gel. When the acetone is completely removed from the wet gel, the temperature and pressure are raised over the threshold points of carbon dioxide. Then, the carbon dioxide is slowly ejected to reduce the pressure while maintaining the temperature at over the threshold temperature.

### Comparative Example 1

An organic aerogel is prepared according to the same process as in Example 1, except that cellulose acetate (39 wt % of acetyl, molecular weight of 30,000 or less), represented by Chemical Formula 4, is used instead of ethyl cellulose.

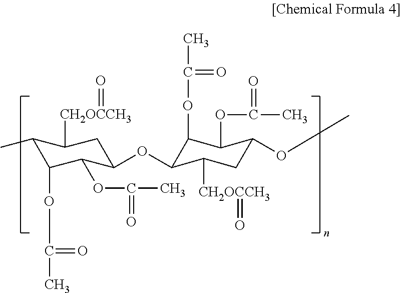

### Comparative Example 2

An organic aerogel is prepared according to the same process as in Example 1, except cellulose acetate (39 wt % of acetyl, molecular weight of 30,000 or less), represented by Chemical Formula 4, is used instead of ethyl cellulose, and toluene diisocyanate, represented by Chemical Formula 5, is used instead of methylene diphenyl diisocyanate.

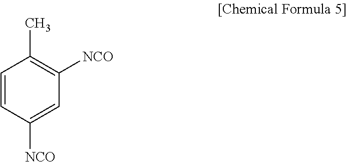

### Comparative Example 3

An organic aerogel is prepared according to the same process as in Example 1, except cellulose acetate (39 wt % of acetyl, molecular weight of 30,000 or less), represented by Chemical Formula 4, is used instead of ethyl cellulose, and an isocyanate polymer represented by Chemical Formula 6 is used instead of methylene diphenyl diisocyanate.

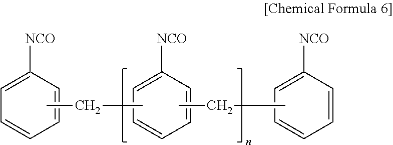

### Evaluation

Confirmation of Organic Aerogel Formation

The shape (e.g., morphology) and pore characteristics of the organic aerogels according to Examples 1 and 2 and Comparatives Example 1 to 3 are evaluated.

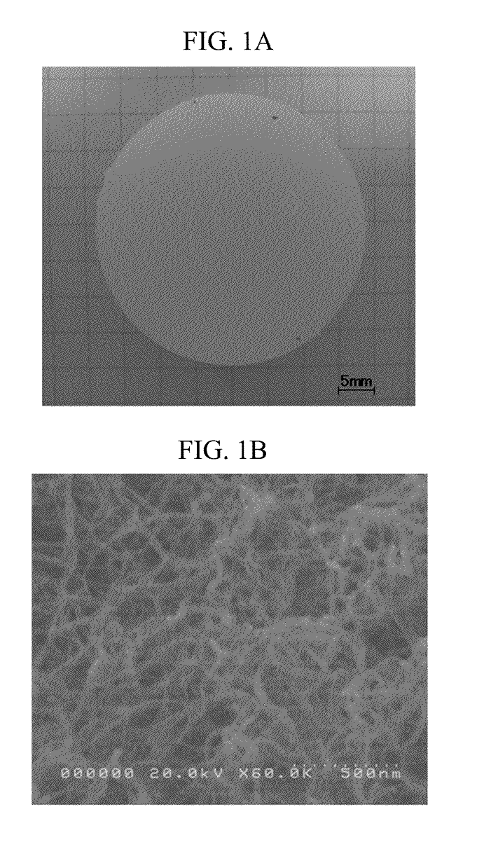

FIGS. 1A to 5B are photographs showing shapes and pores of organic aerogels according to Examples 1 and 2 and Comparative Examples 1 to 3.

Referring to FIG. 1A, the organic aerogel according to Example 1 maintains its initial shape after drying without a change in shape, and referring to FIG. 1B, fine sized pores (e.g., pores having a size on the nanometer scale) of the organic aerogel are shown.

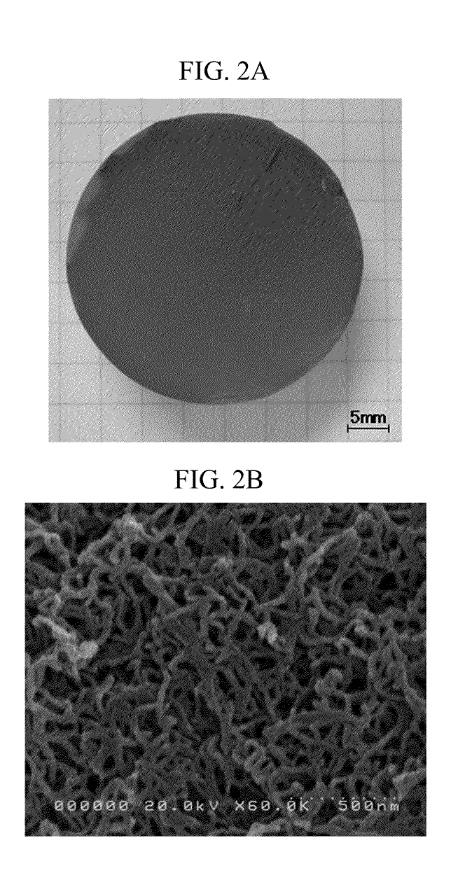

Referring to FIG. 2A, the organic aerogel according to Example 2 maintains its initial shape after drying without a change in shape, and referring to FIG. 2B, fine sized pores (e.g., pores having a size on the nanometer scale) of the organic aerogel are shown.

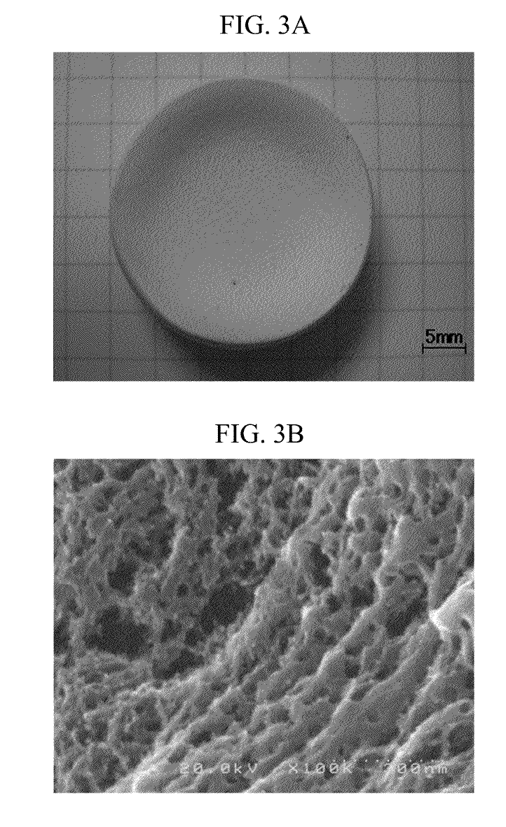

Referring to FIG. 3A, the organic aerogel according to Comparative Example 1 shows a large amount of shrinkage compared with the organic aerogels of Example 1 and Example 2, and referring to FIG. 3B, the uniformity of pore sizes is very low.

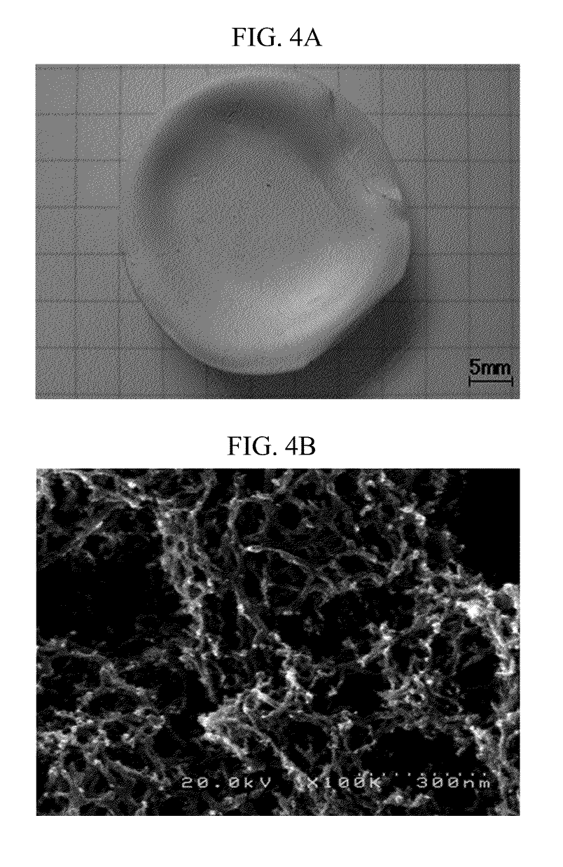

Referring to FIG. 4A, the organic aerogel according to Comparative Example 2 shows a large amount of shrinkage in a thickness direction, which is understood to cause severe (e.g., significant) shape changes, and referring to FIG. 4B, uniformity of pore sizes is low.

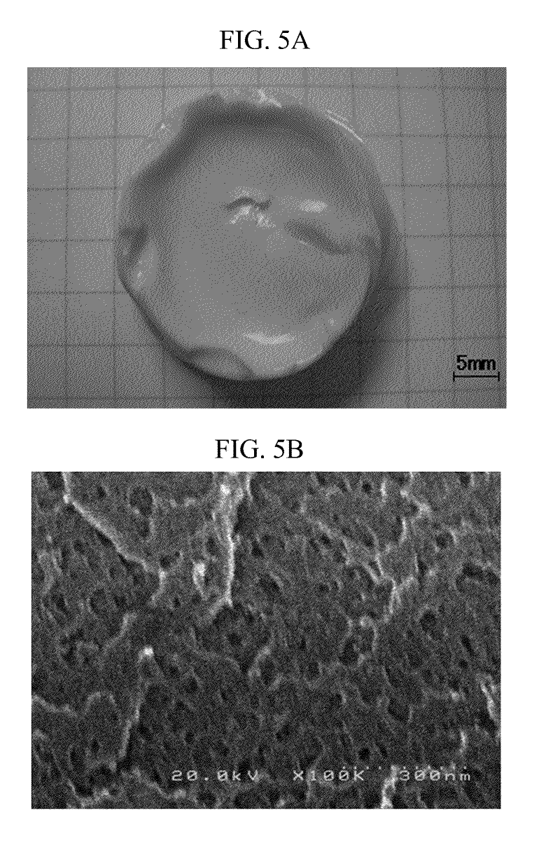

Referring to FIG. 5A, the organic aerogel according to Comparative Example 3 shows a large amount of shrinkage in a thickness direction, which is understood to cause severe (e.g., significant) shape changes, and referring to FIG. 5B, the number (e.g. density) of pores is significantly reduced.

Property-1

The shrinkage, specific surface area, and an average pore size of organic aerogels according to Examples 1 and 2 are measured.

Table 1 shows shrinkage, specific surface area, and average pore size of the organic aerogels.

Herein, the shrinkage (in percent, %) is obtained by calculating a ratio of an alteration in the diameter of the aerogel acquired after supercritical drying to the diameter of the original wet gel after solvent exchange. Mathematically, the shrinkage is calculated to be (diameter of wet gel−diameter of aerogel)/diameter of wet gel×100. The average pore size (in nanometers, m) is measured using a Barrett, Joyner and Halenda (“BJH”) adsorption/desorption isotherm. Specific surface area (in square meters per gram (m2/g) is measured at 77 K with a TriStar3200 specific surface area analyzer (produced by Micromeritics Instruments company, U.S.A.).

TABLE 1

| | Shrinkage | Specific surface area | Average pore size |
|---|---|---|---|
| | (%) | (m²/g) | (nm) |
| Example 1 | <15 | 193.1 | 12.9 |
| Example 2 | <3 | 256.5 | 9.2 |

Referring to Table 1, the organic aerogels of Examples 1 and 2 have relatively low shrinkage, specifically lower than about 15% and lower than about 3%, respectively. The shrinkage of the organic aerogels of Examples 1 and 2 are less than a commercially available cellulose acetate aerogel (see F. Fischer, A. Rigacci, R. Pirard, S. Berthon-Fabry and P. Achard, Polymer 47, (2006), pp. 7636-7645), the shrinkages of which are 75% and 85%. Without being bound by theory, it is believed that the shrinkage is reduced because the ethyl group (alkyl group) bonded to cellulose is more hydrophobic than an acetyl group, and thus the hydrophobic ethyl group increases the hydrophobic property of the wet gel structure.

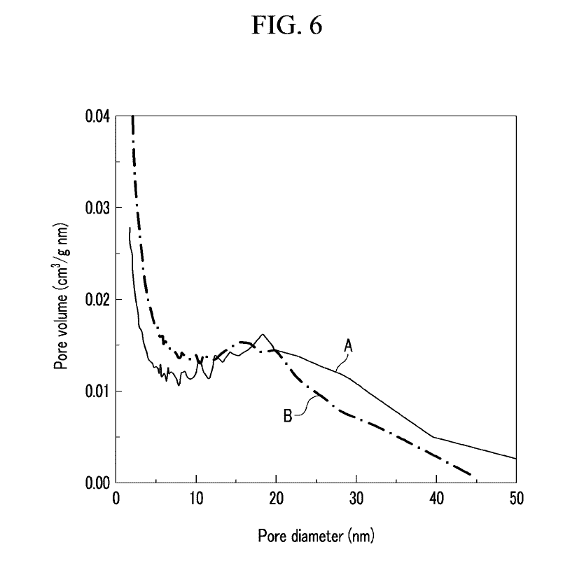

FIG. 6 is a graph showing a pore size distribution of the organic aerogels of Examples 1 and 2.

Referring to FIG. 6, the organic aerogel A of Example 1 and the organic aerogel B of Example 2 have a plurality of pores having a size of about 2 nm to about 100 nm, specifically about 2 nm to about 50 nm, more specifically about 10 nm to about 40 nm. The organic aerogel B of Example 2 has a greater proportion of relatively smaller pores than the organic aerogel A of Example 1.

Property-2

The thermal conductivity of the organic aerogel of Example 2 is measured. A specimen of the organic aerogel has a size of about 115 millimeters (mm) by 121 mm 17 mm, and its thermal conductivity is measured by using an HFM 436 heat flow meter (produced by Netzsch company).

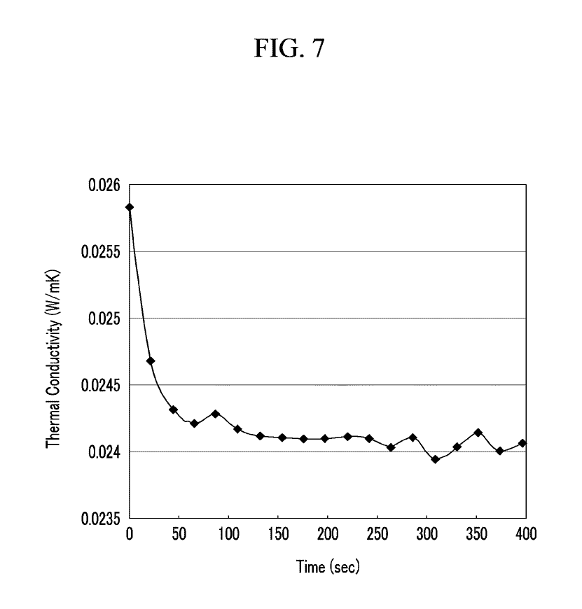

FIG. 7 is a graph showing the thermal conductivity of the organic aerogel of Example 2.

Referring to FIG. 7, the thermal conductivity is measured to be 0.0241 Watts per meter per Kelvin (W/mK). Because the thermal conductivity of the organic aerogel is lower than that of air (0.026 W/mK), the organic aerogel of Example 2 may be used as an adiabatic material.

While this invention has been described in connection with exemplary embodiments, it is to be understood that the invention is not limited to the disclosed embodiments, but, on the contrary, is intended to include various modifications and equivalent arrangements included within the spirit and scope of the appended claims.

What is claimed is:

1. An organic aerogel comprising:
a polymer, the polymer comprising a reaction product of a substituted or unsubstituted alkyl cellulose compound or derivative thereof and a substituted or unsubstituted alkylene diphenyl diisocyanate compound.

2. The organic aerogel of claim 1, wherein the substituted or unsubstituted alkyl cellulose compound or derivative thereof is a compound represented by Chemical Formula 1: 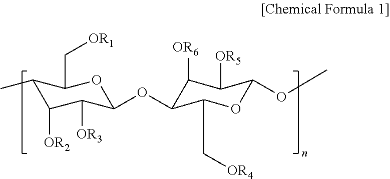
wherein R₁ to R₆ are each independently hydrogen or a C1 to C10 alkyl group,
provided that at least one of R₁ to R₆ is a C1 to C10 alkyl group, and n is about 10 to about 1000.

3. The organic aerogel of claim 1, wherein the substituted or unsubstituted alkylene diphenyl diisocyanate compound is a compound represented by Chemical Formula 2: 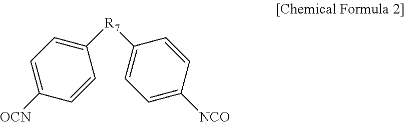
wherein R₇ is a C1 to C20 alkylene group.

4. The organic aerogel of claim 3, wherein the substituted or unsubstituted alkylene diphenyl diisocyanate compound comprises a methylene diphenyl diisocyanate represented by Chemical Formula 2-1:

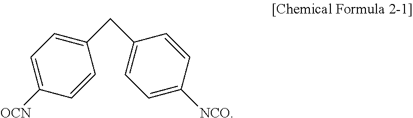

5. The organic aerogel of claim 1, wherein the polymer comprises a cross-linked reaction product of a cross-linkable compound having at least two vinyl groups with the substituted or unsubstituted alkyl cellulose compound or derivative thereof and the substituted or unsubstituted alkylene diphenyl diisocyanate compound.

6. The organic aerogel of claim 5, wherein the cross-linkable compound having at least two vinyl groups comprises a substituted or unsubstituted multifunctional acrylate compound.

7. The organic aerogel of claim 1, wherein the organic aerogel further comprises a plurality of pores having an average pore size of about 2 nanometers to about 100 nanometers.

8. The organic aerogel of claim 7, wherein the polymer has porosity of about 80 percent to about 99 percent, based on the total volume of the polymer.

9. The organic aerogel of claim 1, wherein the organic aerogel has a specific surface area of about 100 square meters per gram to about 1200 square meters per gram.

10. A composition for the manufacture of an organic aerogel, the composition comprising:
a substituted or unsubstituted alkyl cellulose compound or derivative thereof;
a substituted or unsubstituted alkylene diphenyl diisocyanate compound; and
a solvent.

11. The composition for the manufacture of an organic aerogel of claim 10, wherein the substituted or unsubstituted alkyl cellulose compound or derivative thereof is a compound represented by Chemical Formula 1: 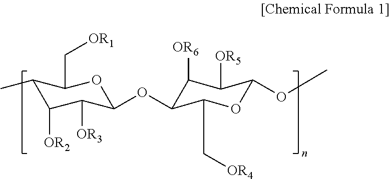
wherein R₁ to R₆ are each independently hydrogen or a C1 to C10 alkyl group,
provided that at least one of R₁ to R₆ is a C1 to C10 alkyl group, and n ranges from 10 to 1000.

12. The composition for the manufacture of an organic aerogel of claim 10, wherein the substituted or unsubstituted alkylene diphenyl diisocyanate compound is a compound represented by Chemical Formula 2: 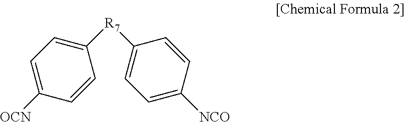
wherein R₇ is a C1 to C20 alkylene group.

13. The composition for the manufacture of an organic aerogel of claim 10, wherein the composition further comprises a compound having at least two vinyl groups.

14. The composition for the manufacture of an organic aerogel of claim 13, wherein the compound having at least two vinyl groups comprises a substituted or unsubstituted multifunctional acrylate compound.

15. A method of manufacturing an organic aerogel, the method comprising:
reacting a substituted or unsubstituted alkyl cellulose compound or derivative thereof and a substituted or unsubstituted alkylene diphenyl diisocyanate compound to form a polymer; and
drying the polymer.

16. The method of claim 15, wherein the reacting is performed at room temperature.

17. The method of claim 16, wherein the reacting performed in the presence of an amine compound.

18. The method of claim 15, further comprising cross-linking the polymer with a compound having at least two vinyl groups.

19. The method of claim 18, wherein the compound having at least two vinyl groups comprises a substituted or unsubstituted multifunctional acrylate compound.

20. The method of claim. 18, wherein the cross-linking is performed at about 40° C. to about 80° C.

21. The method of claim 19, wherein the cross-linking is performed in the presence of a radical initiator.

22. The method of claim 15, wherein the organic aerogel has shrinkage of about 20 percent or less after the drying is performed.
